(19) United States
(12) Patent Application Publication
(10) Pub. No.: US 2025/0202037 A1
(43) Pub. Date: Jun. 19, 2025

(54) BATTERY PACK AND VEHICLE COMPRISING THE SAME

(71) Applicant: LG ENERGY SOLUTION, LTD., Seoul (KR)

(72) Inventor: Dong-Wan KO, Daejeon (KR)

(73) Assignee: LG ENERGY SOLUTION, LTD., Seoul (KR)

(21) Appl. No.: 18/024,117

(22) PCT Filed: May 12, 2022
(86) PCT No.: PCT/KR2022/006840

§ 371 Date: May 3, 2024

(30) Foreign Application Priority Data
May 27, 2021 (KR) 10-2021-0068645

(51) Int. Cl. H01M 50/375; H01M 10/48; H01M 10/6563; H01M 50/24; H01M 50/249; H01M 50/317

(52) U.S. Cl. CPC H01M 50/375; H01M 10/486; H01M 10/6563; H01M 50/24; H01M 50/249; H01M 50/317; H01M 2220/20

(57) ABSTRACT

Disclosed is a battery pack for preventing condensation due to a temperature difference between the inside and the outside of a pack case. To achieve the objective, the battery pack according to the present disclosure includes at least one battery module; the pack case accommodating the at least one battery module, the pack case having at least one air hole to allow air to flow in and out; a control unit configured to determine whether to open or close the air hole according to the temperature difference between inside and outside of the pack case; and a ventilation unit configured to open or close the air hole in response to a control signal from the control unit.

### TECHNICAL FIELD

The present disclosure relates to a battery pack and a vehicle comprising the same, and more particularly, to a battery pack for preventing condensation due to a temperature difference between the inside and the outside of a pack case and a vehicle comprising the same.

The present application claims priority to Korean Patent Application No. 10-2021-0068645 filed on May 27, 2021 in the Republic of Korea, the disclosure of which is incorporated herein by reference.

### BACKGROUND ART

Recently, there has been a rapid increase in the demand for portable electronic products such as laptop computers, video cameras and mobile phones, and with the extensive development of electric vehicles, accumulators for energy storage, robots and satellites, many studies are being made on high performance secondary batteries that can be repeatedly recharged.

Currently, commercially available secondary batteries include nickel-cadmium batteries, nickel-hydrogen batteries, nickel-zinc batteries, lithium secondary batteries and the like, and among them, lithium secondary batteries have little or no memory effect, and thus they are gaining more attention than nickel-based secondary batteries for their advantages that recharging can be done whenever it is convenient, the self-discharge rate is very low and the energy density is high.

The lithium secondary battery usually uses a lithium-based oxide and a carbon material for a positive electrode active material and a negative electrode active material, respectively. Additionally, the lithium secondary battery includes an electrode assembly including a positive electrode plate and a negative electrode plate coated with the positive electrode active material and the negative electrode active material, respectively, with a separator interposed between the positive electrode plate and the negative electrode plate, and a packaging or a battery case in which the electrode assembly is hermetically received together with an electrolyte solution.

The lithium secondary batteries may be classified into can-type and pouch-type according to the shape of the battery case. The can-type secondary battery includes a metal can accommodating the electrode assembly, and the pouch-type secondary battery includes a pouch of an aluminum laminate sheet accommodating the electrode assembly.

More recently, there is a growing demand for high capacity battery packs used in electric vehicles. The high capacity battery pack includes a plurality of battery modules, each including secondary battery cells. The high capacity battery pack mounted in electric vehicles may have an increase in temperature difference between the inside and the outside of the battery packs depending on the outdoor environment in which the vehicle drives. When the temperature difference between the inside and the outside of the battery pack is equal to or larger than 15° C., moisture contained in air inside of the battery pack condenses to produce water droplets on the walls of the pack case. The water droplets flow down and stay in the pack case. Due to the produced water in the pack case, an electrical short occurs between the plurality of battery modules, causing thermal runaway of the battery module or electrical fires when electrical wires come in contact with each other between electrical components in the battery pack.

Accordingly, there is a need for an approach to minimize the electrical short or the contact between electrical wires in the battery pack due to the condensation inside the battery pack.

### DISCLOSURE

### Technical Problem

The present disclosure is designed to solve the above-described problem, and therefore the present disclosure is directed to providing a battery pack for preventing condensation due to a temperature difference between the inside and the outside of a pack case and a vehicle comprising the same.

These and other objectives and advantages of the present disclosure can be understood by the following description, and will be apparent from the embodiments of the present disclosure. In addition, it will be readily appreciated that the objectives and advantages of the present disclosure can be realized by the means set forth in the appended claims and a combination thereof.

### Technical Solution

To solve the above-described technical problem, a battery pack according to the present disclosure includes at least one battery module; a pack case accommodating the at least one battery module, the pack case having at least one air hole to allow air to flow in and out: a control unit configured to determine whether to open or close the air hole according to a temperature difference between inside and outside of the pack case; and a ventilation unit configured to open or close the air hole in response to a control signal from the control unit.

The ventilation unit may include a packing member having a size that is equal to or larger than the air hole to close the air hole; and a transport member configured to transport the packing member toward or away from the air hole in response to the control signal from the control unit.

The transport member may include an electric motor configured to operate in response to the control signal from the control unit; and a transport gear configured to transport the packing member toward or away from the air hole by a rotational force transmitted from the electric motor.

A first toothed wheel may be at a rotating shaft of the electric motor, the transport gear may include a body extended in a direction and having a screw thread on an outer surface, and a second toothed wheel at an end of the body, the second toothed wheel engaged with the first toothed wheel, the packing member may have a screw hole into which the body is inserted, the screw hole having a screw thread on an inner surface, and the ventilation unit may further include a fixing member to fix part of the packing member to prohibit the packing member from making a rotational movement.

The transport member may include a cylinder configured to push a shaft outwards or pull the shaft inwards in response to the control signal from the control unit; and a packing fixing portion at an end of the shaft of the cylinder to fix the packing member.

The battery pack may further include an internal temperature sensor to detect an internal temperature of the pack case; and an external temperature sensor to detect a temperature of air outside of the pack case, and the control unit may be configured to transmit a first control signal to the ventilation unit to enable the ventilation unit to open the air hole when a difference between the internal temperature of the pack case measured by the internal temperature sensor and the external temperature of the pack case measured by the external temperature sensor is equal to or larger than a predetermined level.

The control unit may be configured to transmit the first control signal to the ventilation unit to enable the ventilation unit to open the air hole, and after a predetermined time, transmit a second control signal to enable the ventilation unit to close the air hole.

The battery pack may further include a fan configured to transport air inside of the pack case.

The pack case may have at least two air holes, and the fan may be configured to transport the air inside of the pack case to force the air out through any one of the at least two air holes.

According to another aspect of the present disclosure, there is provided a vehicle including the battery pack.

### Advantageous Effects

According to an aspect of the present disclosure, since the present disclosure includes the control unit to determine whether to open or close the air hole according to the temperature difference between the inside and the outside of the pack case; and the ventilation unit to open or close the air hole in response to the control signal from the control unit, when condensation occurs, i.e., water vapor in air inside of the pack case condenses into water due to the temperature difference between the inside and the outside of the pack case, it is possible to dry out the produced water by opening the air hole to ventilate the pack case through the control of the control unit and the operation of the ventilation unit.

Accordingly, the present disclosure may prevent the contact between electrical wires or an electrical short from occurring in the battery module, the battery cell and the electrical component within the battery pack due to the produced moisture in the pack case.

### DESCRIPTION OF DRAWINGS

FIG. 1 is a perspective view schematically showing a battery pack according to an embodiment of the present disclosure.

FIG. 2 is a diagram schematically showing the inner parts of a battery pack according to an embodiment of the present disclosure.

FIG. 3 is a partial enlarged diagram schematically showing some of the inner parts of a battery pack according to an embodiment of the present disclosure.

FIG. 4 is a diagram schematically showing the inner parts of a battery pack according to another embodiment of the present disclosure.

FIGS. 5 and 6 are diagrams schematically showing some of the inner parts of a battery pack according to still another embodiment of the present disclosure.

FIG. 7 is a diagram schematically showing the inner parts of a battery pack according to yet another embodiment of the present disclosure.

FIG. 8 is a diagram schematically showing the inner parts of a battery pack according to a further another embodiment of the present disclosure.

FIG. 9 is a perspective view schematically showing a vehicle according to an embodiment of the present disclosure.

### BEST MODE

Hereinafter, the exemplary embodiment of the present disclosure will be described in detail with reference to the accompanying drawings. Prior to the description, it should be understood that the terms or words used in the specification and the appended claims should not be construed as being limited to general and dictionary meanings, but rather interpreted based on the meanings and concepts corresponding to the technical aspects of the present disclosure on the basis of the principle that the inventor is allowed to define the terms appropriately for the best explanation.

Therefore, the embodiments described herein and the illustrations shown in the drawings are just an exemplary embodiment of the present disclosure, but not intended to fully describe the technical aspects of the present disclosure, so it should be understood that a variety of other equivalents and modifications could have been made thereto at the time that the application was filed.

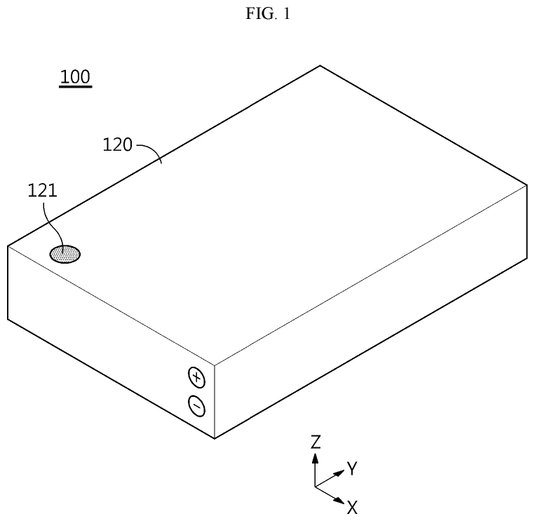

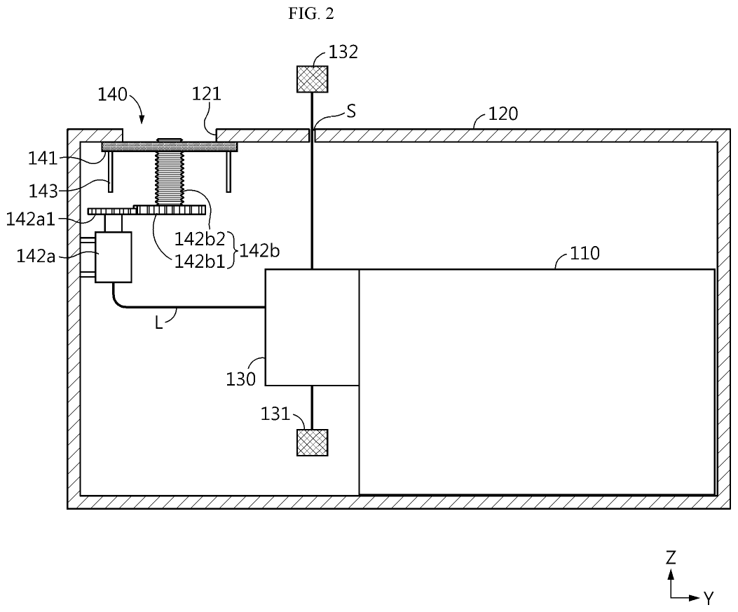

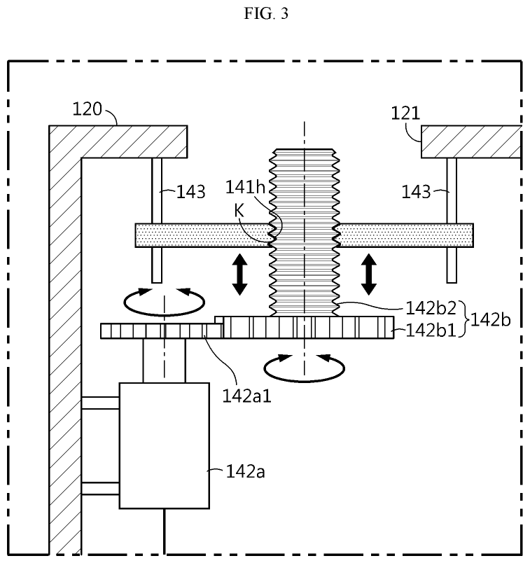

FIG. 1 is a perspective view schematically showing a battery pack according to an embodiment of the present disclosure. FIG. 2 is a diagram schematically showing the inner parts of the battery pack according to an embodiment of the present disclosure. Additionally, FIG. 3 is a partial enlarged diagram schematically showing some of the inner parts of the battery pack according to an embodiment of the present disclosure. For reference, in FIG. 1, the X axis direction is the right direction, the Y axis direction is the rear direction and the Z axis direction is the up direction.

Referring to FIGS. 1 to 3, the battery pack 100 according to an embodiment of the present disclosure includes at least one battery module 110, a pack case 120, a control unit 130 and a ventilation unit 140.

Specifically, the battery module 110 may include a plurality of battery cells (not shown) and a module case accommodating the plurality of battery cells (not shown).

Here, the battery cells may include, for example, pouch-type battery cells that have high energy density and are easy to stack. The pouch-type battery cells may be stacked to form a battery cell group. The battery cells may have electrode leads at left and right ends. However, as opposed to this embodiment, the battery cells of the present disclosure are not limited to the pouch-type battery cells, and prismatic battery cells of rectangular prism shape or cylindrical battery cells may be used.

Although not shown in the drawings, the plurality of battery cells may be electrically connected by a busbar including an electrically conductive metal. The busbar may have a metal rod or metal plate shape. The busbar may include any known common connection member configured to electrically connect the plurality of battery cells. Its description is omitted.

Furthermore, the module housing is the component used to receive the plurality of battery cells (not shown), and may be formed with a hermetic structure using a material having high mechanical strength to protect the plurality of battery cells from external physical and chemical factors. For example, the module housing of the battery module 110 may be coupled to the pack case 120 by bolting and/or welding.

Additionally, the pack case 120 may be configured to accommodate the at least one battery module 110 therein. The pack case 120 may be formed with a hermetic structure using a material having high mechanical strength to protect the battery module 110 and the control unit 130 from external physical and chemical factors. The pack case 120 may have at least one air hole 121 to allow air to flow in and out. For example, as shown in FIGS. 1 and 2, the pack case 120 may have one air hole 121 on top of the pack case 120 to allow air to flow in and out. The opening shape of the air hole 121 is not limited to a particular shape, but may be, for example, a circular or square shape.

Further, the control unit 130 may be configured to determine whether to open or close the air hole 121 according to a temperature difference between the inside and the outside of the pack case 120. For example, when the temperature difference between the inside and the outside of the pack case 120 is equal to or larger than 15° C., the control unit 130 may be configured to transmit a control signal to the ventilation unit 140 to enable the ventilation unit 140 to open the air hole 121. However, the range of the temperature difference is not necessarily limited to 15° C. or above, and the internal and external environmental factors (for example, temperature, humidity) of the battery pack 100 may be considered when determining whether to open or close the air hole 121. The control unit 130 may include a memory chip to store the collected temperature information. The control unit 130 may include a microcontroller to determine whether to open or close the air hole 121 according to the size of the temperature difference. The control unit 130 may include a communication unit to transmit the control signal to the ventilation unit 140. The communication unit may perform wireless communication or wired communication using a communication line L.

Additionally, the ventilation unit 140 may be configured to directly close the air hole 121 in response to the control signal from the control unit 130. The ventilation unit 140 may be configured to directly open the air hole 121 in response to the control signal from the control unit 130. The method for closing the air hole 121 is not limited to a particular method, and may include any method for closing the air hole 121.

According to this configuration of the present disclosure, since the present disclosure includes the control unit 130 to determine whether to open or close the air hole 121 according to the temperature difference between the inside and the outside of the pack case 120; and the ventilation unit 140 to open or close the air hole 121 in response to the control signal from the control unit 130, when condensation occurs, i.e., water vapor in air inside of the pack case 120 condenses into water due to the temperature difference between the inside and the outside of the pack case 120, it is possible to dry out the produced water by opening the air hole 121 to ventilate the pack case 120 through the control of the control unit 130 and the operation of the ventilation unit 140. Accordingly, the present disclosure may prevent the contact between electrical wires or an electrical short from occurring in the battery module 110, the battery cell and the electrical component in the battery pack 100 due to the produced moisture (water) in the pack case 120.

Furthermore, when the ventilation unit 140 opens the air hole 121, the battery pack 100 of the present disclosure may allow outdoor air to flow in through the air hole 121 of the pack case 120 and air inside of the pack case 120 to flow out through the air hole 121, thereby reducing the temperature difference between the inside and the outside of the pack case 120, and thus preventing any further condensation from occurring in the pack case 120.

Referring back to FIGS. 1 to 3, the ventilation unit 140 of the battery pack 100 of the present disclosure may include a packing member 141 and a transport member 142. The packing member 141 may be configured to close the air hole 121. The size of the packing member 141 may be equal to or larger than the size of the air hole 121. The material of the packing member 141 may include synthetic rubber or natural rubber. For example, the packing member 141 may be ethylene propylene rubber. When the air hole 121 is, for example, circular, the packing member 141 may have a disc shape having a predetermined thickness. However, the shape of the packing member 141 is not limited to a particular shape, and the shape of the packing member 141 may be set according to the shape of the air hole 121. That is, the packing member 141 may have any shape that closes (covers) the air hole 121.

Additionally, the transport member 142 may be configured to operate in response to the control signal from the control unit 130. The transport member 142 may receive the control signal from the control unit 130 to transport the packing member 141 toward the air hole 121. The transport member 142 may receive the control signal from the control unit 130 to transport the packing member 141 in a direction facing away from the air hole 121. That is, the packing member 141 may be transported by the transport member 142 to bring it into close contact with the air hole 121 or move it away from the air hole 121. For example, the transport member 142 may include a receiver to receive a communication signal from the control unit 130.

According to this configuration of the present disclosure, since the present disclosure includes the ventilation unit 140 including the packing member 141 and the transport member 142, the air hole 121 of the pack case 120 may be opened or closed according to the temperature difference between the inside and the outside of the pack case 120. Accordingly, when the ventilation unit 140 opens the air hole 121, the battery pack 100 of the present disclosure may allow outdoor air to flow in through the air hole 121 of the pack case 120 and air inside of the pack case 120 to flow out through the air hole 121, thereby reducing the temperature difference between the inside and the outside of the pack case 120, and thus preventing any further condensation from occurring in the pack case 120.

Referring back to FIGS. 1 to 3, the transport member 142 of the ventilation unit 140 of the battery pack 100 of the present disclosure may include an electric motor 142a and a transport gear 142b. The electric motor 142a may be configured to operate in response to the control signal (an electrical signal) from the control unit 130. For example, the electric motor 142a may be a servo motor that operates according to the control signal of the control unit 130. The electric motor 142a may have a rotating shaft configured to make rotational movement when power is supplied.

Additionally, the transport gear 142b may be configured to transport the packing member 141 toward the air hole 121 by a rotational force transmitted from the electric motor 142a. The transport gear 142b may be configured to transport the packing member 141 in the direction facing away from the air hole 121 by the rotational force transmitted from the electric motor 142a. For example, when the rotating shaft of the electric motor 142a rotates in the counterclockwise direction, the transport gear 142b may transport the packing member 141 toward the air hole 121. When the rotating shaft of the electric motor 142a rotates in the clockwise direction, the transport gear 142b may transport the packing member 141 in the direction facing away from the air hole 121.

According to this configuration of the present disclosure, since the present disclosure includes the electric motor 142a and the transport gear 142b, it is easy to control the opening/closing of the air hole 121 according to the electrical signal from the control unit 130.

Furthermore, a first toothed wheel 142al may be at the rotating shaft of the electric motor 142a. The first toothed wheel 142al may have a disc shape. The first toothed wheel 142al may rotate in the clockwise direction or the counterclockwise direction by the rotation of the rotating shaft.

Additionally, the transport gear 142b may include a body 142b2 extended in a direction. The body 142b2 may have a screw thread on the outer surface. The screw thread may be a male thread. A second toothed wheel 142b1 may be at one end of the body 142b2. The second toothed wheel 142b1 may engaged with the first toothed wheel 142al. For example, when the first toothed wheel 142al rotates in the clockwise direction, the second toothed wheel 142b1 may rotate in the counterclockwise direction. On the contrary, when the first toothed wheel 142al rotates in the counterclockwise direction, the second toothed wheel 142b1 may rotate in the clockwise direction. The transport gear 142b may only allow a rotational motion, and the position of the transport gear 142b may be fixed. For example, the transport gear 142b may include a fixing member including a ring around the outer surface of the body 142b2. The ring may be configured to allow the rotational movement of the transport gear 142b and limit the movement of the position of the transport gear 142b.

Further, the packing member 141 may have a screw hole 141h into which the body 142b2 is inserted. The screw hole 141h may have a screw thread on the inner surface. The screw thread may be a female thread. For example, when the body 142b2 of the transport gear 142b rotates in the counterclockwise direction, the packing member 141 may move to the air hole 121 along the outer surface of the body 142b2 of the transport gear 142b. When the body 142b2 of the transport gear 142b rotates in the clockwise direction, the packing member 141 may move in the direction facing away from the air hole 121 along the screw thread on the outer surface of the body 142b2 of the transport gear 142b. However, the present disclosure is not necessarily limited to this method, and the transportation direction may change depending on the type of the screw, for example, a right screw or a left screw.

Additionally, the ventilation unit 140 may further include the fixing member 143 to fix part of the packing member 141. The fixing member 143 may be configured to prohibit the rotational movement of the packing member 141. For example, as shown in FIG. 3, the fixing member 143 may include two fixing pins. Each of the two fixing pins may be, at one end, fixed to the pack case 120. Each of the two fixing pins may be configured to pass through the packing member 141. That is, the packing member 141 may be configured to move up and down along the outer surface of the fixing pin. In other words, when the packing member 141 is transported toward the air hole 121 along the screw thread of the body 142b2 of the transport gear 142b, the packing member 141 may be moved to the air hole 121 along the outer surface of the two fixing pins. On the contrary, when the packing member 141 is transported in the direction facing away from the air hole 121 by the transport gear 142b, the packing member 141 may be moved away from the air hole 121 along the outer surface of the two fixing pins. That is, the two fixing pins may be configured to allow the packing member 141 to move in two directions, but prohibit the packing member 141 from making rotational movement when the packing member 141 receives the rotational force from the transport gear 142b. Although the fixing pin has been described as an embodiment of the fixing member 143, the fixing member 143 is not necessarily limited to this configuration, and may include any fixing member configured to prohibit the packing member 141 from making rotational movement but allow the packing member 141 to move closer to the air hole 121 or away from the air hole 121.

According to this configuration of the present disclosure, since the present disclosure includes the first toothed wheel 142al at the rotating shaft of the electric motor 142a, the transport gear 142b including the body 142b2 extended in a direction and having the screw thread on the outer surface, and the second toothed wheel 142b1 engaged with the first toothed wheel 142al at one end of the body 142b2, the packing member 141 having the screw hole 141h into which the body 142b2 is inserted and having the screw thread on the inner surface, and the ventilation unit 140 further including the fixing member 143 to fix part of the packing member 141 to prohibit the packing member 141 from making rotational movement, it is possible to precisely transport the packing member 141 using the transport member 142. Accordingly, the present disclosure may precisely control the opening/closing of the air hole 121 of the pack case 120, and reduce malfunctions. Ultimately, the present disclosure may effectively prevent the contact between electrical wires or an electrical short from occurring in the battery module 110, the battery cell and the electrical component within the battery pack 100 due to condensation in the battery pack 100.

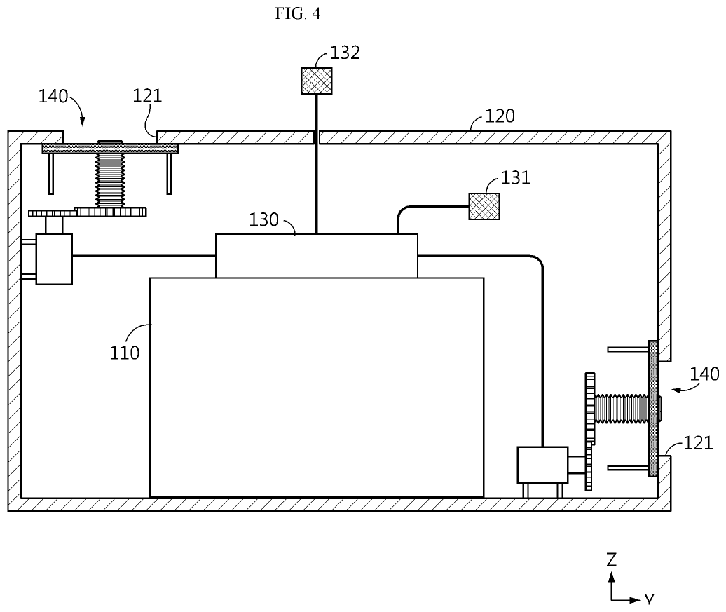

FIG. 4 is a diagram schematically showing the inner parts of a battery pack according to another embodiment of the present disclosure.

Referring to FIG. 4, as opposed to the battery pack 100 of FIG. 2, the battery pack 100 according to another embodiment of the present disclosure may have two air holes 121 of the pack case 120. Additionally, as opposed to the battery pack 100 of FIG. 2, the battery pack 100 may include two ventilation units 140. The components of the battery pack 100 of FIG. 4 may be the same as those of the battery pack 100 of FIG. 2, only different in position.

Specifically, the battery pack 100 according to another embodiment of the present disclosure may have the two air holes 121 at the top and the rear end of the pack case 120, respectively. The two ventilation units 140 may close each of the two air holes 121 in response to the control signal from the control unit 130. Alternatively, the two ventilation units 140 may be configured to open each of the two air holes 121 in response to the control signal from the control unit 130. In this instance, when the two air holes 121 are opened by the ventilation unit 140, any one of the two air holes 121 may be configured to allow air outside of the pack case 120 to flow in. Additionally, the remaining air hole 121 may act as a passage through which air inside of the pack case 120 flows out.

According to this configuration of the present disclosure, since the battery pack 100 of the present disclosure includes the two air holes 121 and the two ventilation units 140 to open or close each of the two air holes 121, it is possible to allow air to flow into and out of the pack case 120 more smoothly. Accordingly, the battery pack 100 of the present disclosure may ventilate the pack case 120 faster, thereby allowing moisture produced by condensation out fast or preventing condensation from progressing.

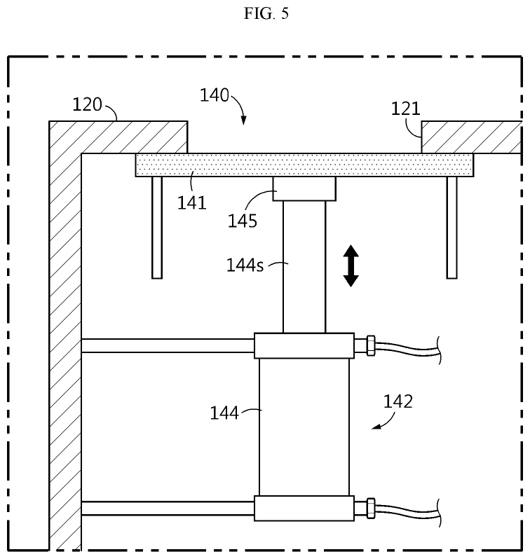

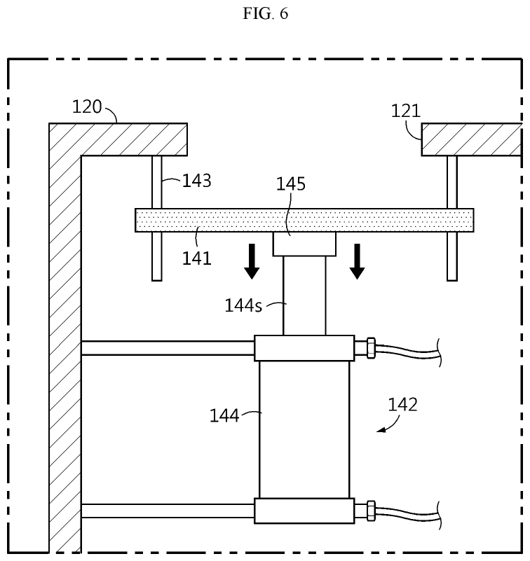

FIGS. 5 and 6 are diagrams schematically showing some of the inner parts of a battery pack according to still another embodiment of the present disclosure.

Referring to FIGS. 5 and 6, as opposed to the battery pack 100 of FIG. 2, the battery pack 100 according to still another embodiment of the present disclosure may include a cylinder 144 and a packing fixing portion 145 as the transport member 142. That is, the battery pack 100 of FIG. 5 does not include the electric motor 142a and the transport gear 142b of the battery pack 100 of FIG. 2. The remaining components of the battery pack 100 according to still another embodiment of the present disclosure may be the same as those of the battery pack 100 of FIG. 2.

Specifically, the cylinder 144 may be configured to push a shaft outwards according to the control signal from the control unit 130. The cylinder 144 may be configured to pull the shaft inwards according to the control signal from the control unit 130. That is, when the temperature difference between the inside and the outside of the pack case 120 is equal to or larger than the predetermined level, the control unit 130 may be configured to transmit the control signal to the ventilation unit 140 to enable the cylinder 144 pull the shaft inwards. In this instance, the packing member 141 may be transported in the direction facing away from the air hole 121. On the contrary, when the temperature difference between the inside and the outside of the pack case 120 is lower than the predetermined level, the control unit 130 may transmit the control signal to the ventilation unit 140 to enable the cylinder 144 to push the shaft outwards. In this instance, the packing member 141 may be transported toward the air hole 121 to close the air hole 121.

Additionally, the packing fixing portion 145 may be at the end of the shaft of the cylinder 144. The packing fixing portion 145 may be configured to fix the packing member 141. For example, the end of the packing fixing portion 145 may be fixed to one side of the packing member 141. The end of the packing fixing portion 145 may be attached to the packing member 141 using an adhesive. That is, the packing member 141 attached to the packing fixing portion 145 at the end of the shaft of the cylinder 144 may be transported by the movement of the shaft of the cylinder 144.

According to this configuration of the present disclosure, since the transport member 142 of the battery pack 100 of the present disclosure includes the cylinder 144 and the packing fixing portion 145, it is possible to effectively control the opening/closing of the air hole 121 of the pack case 120 by the control of the ventilation unit 140 by the control unit 130. Accordingly, the present disclosure may precisely control the opening/closing of the air hole 121 of the pack case 120, and reduce malfunctions. Ultimately, the present disclosure may effectively prevent the contact between electrical wires or an electrical short from occurring in the battery module 110, the battery cell and the electrical component within the battery pack 100 due to condensation in the battery pack 100.

Referring back to FIG. 2, the battery pack 100 according to an embodiment of the present disclosure may include an internal temperature sensor 131 and an external temperature sensor 132. The internal temperature sensor 131 may be a sensor to detect the temperature of air inside of the pack case 120. The internal temperature sensor 131 may be disposed in the pack case 120. The internal temperature sensor 131 may have a resistance of a predetermined value according to the detected temperature. The control unit 130 may read the predetermined resistance value of the internal temperature sensor 131 through an electrical wire in which electric current flows. The internal temperature sensor 131 may be a resistance temperature sensor.

Additionally, the external temperature sensor 132 may be configured to detect the temperature of air outside of the pack case 120. The external temperature sensor 132 may be disposed outside of the pack case 120. The external temperature sensor 132 may have a resistance of a predetermined value according to the detected temperature. The control unit 130 may read the predetermined resistance value of the external temperature sensor 132 through an electrical wire in which electric current flows. The external temperature sensor 132 may be a resistance temperature sensor. The electrical wire may electrically connect the external temperature sensor 132 to the control unit 130 through a small hole of the pack case 120.

Furthermore, when the difference between the temperature of air inside of the pack case 120 measured by the internal temperature sensor 131 and the temperature of air outside of the pack case 120 measured by the external temperature sensor 132 is equal to or larger than the predetermined level, the control unit 130 may be configured to transmit a first control signal to the ventilation unit 140 to enable the ventilation unit 140 to open the air hole 121. For example, when the difference in temperature measured by each of the internal temperature sensor 131 and the external temperature sensor 132 is equal to or larger than 15° C., the control unit 130 may be configured to transmit the first control signal to the ventilation unit 140 to open the air hole 121. However, the range of the temperature difference is not necessarily limited to 15° C. or above, and the internal and external environmental factors (for example, temperature, humidity) of the battery pack 100 may be considered when determining whether to open or close the air hole 121.

Additionally, a predetermined time after transmitting the first control signal to enable the ventilation unit 140 to open the air hole 121, the control unit 130 may be configured to transmit a second control signal to enable the ventilation unit 140 to close the air hole 121. For example, 10 minutes after transmitting the first control signal to enable the ventilation unit 140 to open the air hole 121, the control unit 130 may transmit the second control signal to the ventilation unit 140 again to enable the ventilation unit 140 to close the air hole 121. That is, the control unit 130 may perform control to close the air hole 121 to prevent outdoor air from entering the pack case 120 during normal operation. However, when the temperature difference between the inside and the outside of the pack case 120 is equal to or larger than the predetermined level, the control unit 130 may determine that condensation occurred, and transmit the control signal to the ventilation unit 140 to open the air hole 121.

Additionally, the period of time during which the ventilation unit 140 keeps the air hole 121 open may change depending on the size of the temperature difference between the inside and the outside of the pack case 120. For example, the control unit 130 may perform control to keep the air hole 121 open for a longer time as the temperature difference between the inside and the outside of the pack case 120 is larger.

According to this configuration of the present disclosure, since the control unit 130 of the battery pack 100 of the present disclosure is configured to transmit the first control signal to enable the ventilation unit 140 to open the air hole 121, and after the predetermined time, transmit the second control signal to enable the ventilation unit 140 to close the air hole 121, the control unit 130 may properly control the period of time during which the air hole 121 of the pack case 120 is open, thereby effectively releasing moisture produced by condensation from the pack case 120. Additionally, the present disclosure may properly reduce the temperature difference between the inside and the outside of the pack case 120.

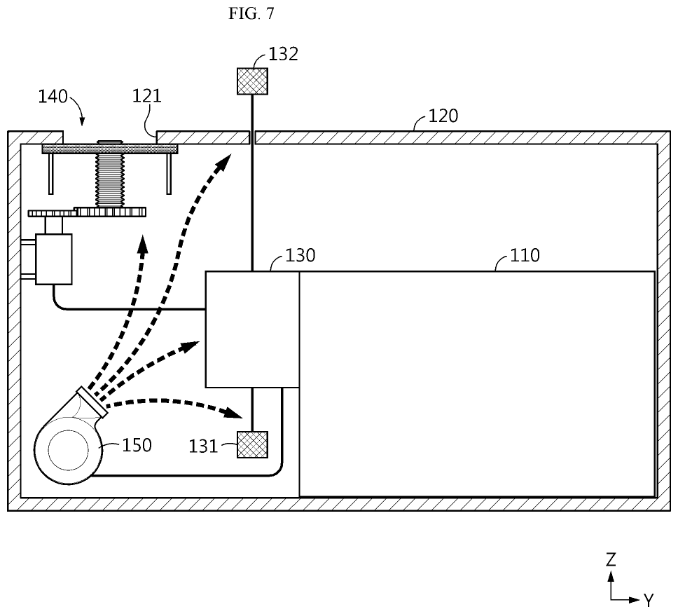

FIG. 7 is a diagram schematically showing the inner parts of a battery pack according to yet another embodiment of the present disclosure.

Referring to FIG. 7, when compared with the battery pack 100 of FIG. 2, the battery pack 100 according to yet another embodiment of the present disclosure may further include a fan 150. The remaining components of the battery pack 100 of FIG. 7 may be the same as those of the battery pack 100 of FIG. 2.

Specifically, the fan 150 may be configured to transport air inside of the pack case 120. For example, as shown in FIG. 7, the fan 150 may blow air inside of the pack case 120 to allow the air to circulate. That is, the fan 150 may minimize the dead space in which air inside of the pack case 120 does not circulate. When the temperature difference between the inside and the outside of the pack case 120 is equal to or larger than the predetermined level, the control unit 130 may be configured to allow the fan 150 to blow air inside of the pack case 120. That is, when the control unit 130 controls the ventilation unit 140 to open the air hole 121, the control unit 130 may operate the fan 150 to circulate air inside of the pack case 120. In this instance, air inside of the pack case 120 containing moisture may exit the air hole 121.

According to this configuration of the present disclosure, since the present disclosure further includes the fan 150, it is possible to effectively remove moisture at the corners (the edges) of the pack case 120. Additionally, it is possible to release moisture into the atmosphere through the air hole 121 quickly by accelerating the flow rate of air in the pack case 120. Additionally, the fan 150 may force water vapor out through the air hole 121 after converting the water droplets in the pack case 120 produced by condensation to the water vapor fast (evaporation).

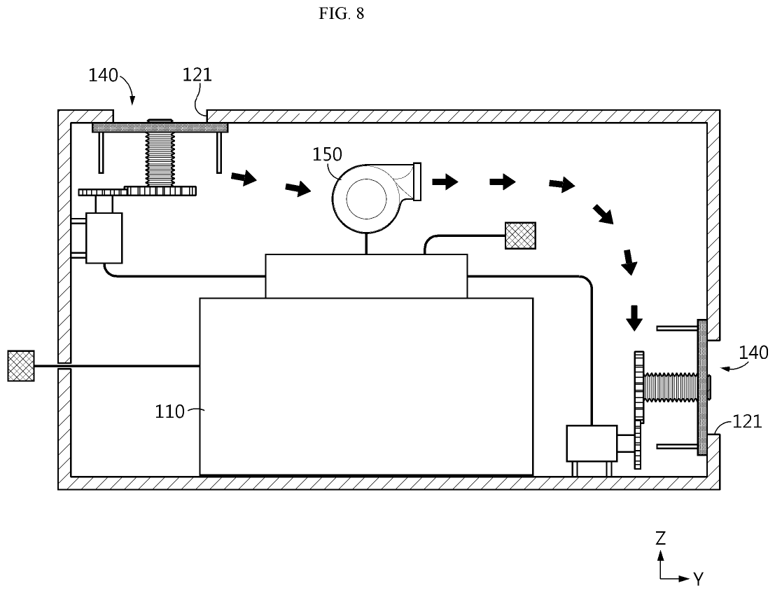

FIG. 8 is a diagram schematically showing the inner parts of the battery pack 100 according to a further another embodiment of the present disclosure.

Referring to FIG. 8, when compared with the battery pack 100 of FIG. 7, the battery pack 100 according to a further another embodiment of the present disclosure may have two air holes 121 in the pack case 120. The remaining components of the battery pack 100 of FIG. 8 are similar to those of the battery pack 100 of FIG. 7, only different in positional characteristics and size.

Specifically, the pack case 120 may have at least two air holes 121. The fan 150 may be configured to transport air inside of the pack case 120 to force the air out through any one of the at least two air holes 121. For example, as shown in FIG. 8, the battery pack 100 of the present disclosure may have the air holes 121 at the top and the rear end of the pack case 120, respectively. The fan 150 may blow air inside of the pack case 120 to force the air out through the air hole 121 at the rear end among the two air holes 121.

According to this configuration of the present disclosure, since the present disclosure includes the fan 150 configured to transport air inside of the pack case 120 to force the air out through any one of the at least two air holes 121, one air hole 121 may be configured to allow the flow of air from the outside to the inside of the pack case 120 and the other air hole 121 may be configured to allow the flow of air from the inside to the outside of the pack case 120, thereby removing moisture in the pack case 120 quickly and reducing the temperature difference between the inside and the outside of the pack case 120 quickly. Accordingly, the battery pack 100 of the present disclosure may remove moisture produced by condensation in the battery pack 100, thereby preventing an internal short circuit or the contact between electrical wires in the battery module 110 due to the moisture. Additionally, the battery pack 100 of the present disclosure may prevent the temperature difference between the inside and the outside of the pack case 120 from increasing to above the predetermined level, thereby preventing condensation.

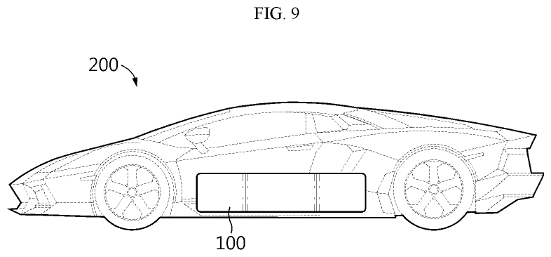

FIG. 9 is a perspective view schematically showing a vehicle according to an embodiment of the present disclosure.

Referring to FIG. 9 together with FIG. 1, the vehicle 200 according to an embodiment of the present disclosure may include at least one battery pack 100. The vehicle may include, for example, a vehicle body in which the battery pack 100 including at least one battery module (not shown) is mounted. For example, the vehicle may be an electric vehicle, an electric scooter, an electric wheelchair or an electric bike.

Referring to FIG. 9 together with FIG. 1, the vehicle 200 according to an embodiment of the present disclosure may include at least one battery pack 100. The vehicle may include, for example, a vehicle body in which the battery pack 100 including at least one battery module (not shown) is mounted. For example, the vehicle may be an electric vehicle, an electric scooter, an electric wheelchair or an electric bike.

Meanwhile, the terms indicating directions as used herein such as upper, lower, left, right, front and rear are used for convenience of description only, and it is obvious to those skilled in the art that the term may change depending on the position of the stated element or an observer.

While the present disclosure has been hereinabove described with regard to a limited number of embodiments and drawings, the present disclosure is not limited thereto and it is obvious to those skilled in the art that various modifications and changes may be made thereto within the technical aspects of the present disclosure and the scope of the appended claims and equivalents thereof.

What is claimed is:

1. A battery pack, comprising:
at least one battery module;
a pack case accommodating the at least one battery module, the pack case having at least one air hole to allow air to flow in and out;
a control unit configured to determine whether to open or close the air hole according to a temperature difference between inside and outside of the pack case; and
a ventilation unit configured to open or close the air hole in response to a control signal from the control unit.

2. The battery pack according to claim 1, wherein the ventilation unit includes:
a packing member having a size that is equal to or larger than the air hole to close the air hole; and
a transport member configured to transport the packing member toward or away from the air hole in response to the control signal from the control unit.

3. The battery pack according to claim 2, wherein the transport member includes:
an electric motor configured to operate in response to the control signal from the control unit; and
a transport gear configured to transport the packing member toward or away from the air hole by a rotational force transmitted from the electric motor.

4. The battery pack according to claim 3, wherein a first toothed wheel is at a rotating shaft of the electric motor,
wherein the transport gear includes a body extended in a direction and having a screw thread on an outer surface, and a second toothed wheel at an end of the body, the second toothed wheel engaged with the first toothed wheel,
wherein the packing member has a screw hole into which the body is inserted, the screw hole having a screw thread on an inner surface, and
wherein the ventilation unit further includes a fixing member to fix part of the packing member to prohibit the packing member from making a rotational movement.

5. The battery pack according to claim 2, wherein the transport member includes:
a cylinder configured to push a shaft outwards or pull the shaft inwards in response to the control signal from the control unit; and
a packing fixing portion at an end of the shaft of the cylinder to fix the packing member.

6. The battery pack according to claim 1, further comprising:
an internal temperature sensor to detect an internal temperature of the pack case; and
an external temperature sensor to detect a temperature of air outside of the pack case,
wherein the control unit is configured to transmit a first control signal to the ventilation unit to enable the ventilation unit to open the air hole when a difference between the internal temperature of the pack case measured by the internal temperature sensor and the external temperature of the pack case measured by the external temperature sensor is equal to or larger than a predetermined level.

7. The battery pack according to claim 6, wherein the control unit is configured to transmit the first control signal to the ventilation unit to enable the ventilation unit to open the air hole, and after a predetermined time, transmit a second control signal to enable the ventilation unit to close the air hole.

8. The battery pack according to claim 1, further comprising:
a fan configured to transport air inside of the pack case.

9. The battery pack according to claim 8, wherein the pack case has at least two air holes, and
wherein the fan is configured to transport the air inside of the pack case to force the air out through any one of the at least two air holes.

10. A vehicle comprising the battery pack according to any one of claims 1 to 9.
